(19) United States
(12) Patent Application Publication
(10) Pub. No.: US 2011/0183094 A1
(43) Pub. Date: Jul. 28, 2011

(54) UNSTAYED COMPOSITE MAST

(76) Inventor: Bo Blomqvist, Waxholm (SE)

(21) Appl. No.: 13/002,231

(22) PCT Filed: Jun. 30, 2009
(86) PCT No.: PCT/SE09/50843

§ 371 Date: Mar. 22, 2011

(30) Foreign Application Priority Data
Jun. 30, 2008 (SE) 0801541-4

(51) Int. Cl. B29C 65/70; B32B 1/06; B29C 67/20

(52) U.S. Cl. 428/36.1; 156/78; 264/46.6

(57) ABSTRACT

A new light and durable construction for posts including an inner pre-stressed tube or pole or wire or fibre rope. The construction includes an outer cover of composite fibre material and a polymer foam that has been added to the tube profile which the outer cover has formed and the polymer foam expanded and cured in situ.

### FIELD OF TECHNOLOGY

The present invention relates to posts of composite construction and methods of producing them.

### BACKGROUND

Today's posts are often very strong but at the same time very heavy. Their purpose is often to support or stay an object and therefore must be able to withstand certain stresses. A lamppost shall be able to withstand heavy winds without falling down. A mast must be able to withstand the forces that arise when the wind fills the sails but at the same time it must be light enough to allow the boat to move forward.

Both lampposts and masts are today often made of metal, even though you still can see wood constructions in both cases. Lampposts may also be made of concrete. All these materials meet, in the main, the strength requirements but today metal is probably the most common material for the construction of posts, masts and poles. However, the problem with metal is the weight. Even though aluminium, which is a relatively light metal, is used more and more, it still has a density of almost 3 ton/m³ which leads to that a contemporary boat rig with a 10 m mast weighs about 100 kg. A heavy mast not only means that you add the kilos of the rig itself to a sailboat but also that the boat needs to have a counteracting weight in the keel/hull to avoid the boat from tipping over, in this case of about 1600 kg. This is both expensive and makes the boat's performance worse. Several constructions have been developed where for example the weight can be decreased.

U.S. Pat. No. 3,429,758 contains a construction of a lamppost with a hollow core. The core is surrounded by glass fibre walls which in turn have a layer of foam (polyurethane foam) on the outside. Farthest out is a layer of glass fibre applied together with a matrix. The post is built on the outside of a mould core which is removed when the matrix is cured and leaves a hollow core.

GB-1,316,798 describes a construction method for the mass production of masts. The mast construction has a foam core which is made first and which is then covered with a fibre material together with a matrix. Luff grooves may easily be incorporated into the construction. Since the mast does not predominantly comprise metals or other heavy materials the construction is light.

The problem still remains of how to obtain enough strength at the same time as the construction preferably should be light. The present invention comprises a construction comprising a foam core and a composite fibre material, comprising fibres and a matrix of polymeric material, which give the desired lightness, and a pre-stressed wire, fibre rope, pole or a tube in the middle which gives the necessary strength.

In another embodiment the present construction has anti-shearing devices at strategic places which hinder fatigue of the material and shearing of the composite fibre material.

### SUMMARY OF THE INVENTION

The aim of the present invention is to supply a construction which in a simple manner provides a light and strong post. The construction should enable the post to be light but still fulfil the necessary strength requirements. The post has a core of polymeric foam and an outer cover of composite fibre material.

In this application the word “post” is defined as an elongated construction for the purpose of bearing, staying or supporting something. The term “post” includes, but is not limited to, terms as mast, baulk, post and pole.

A preferred embodiment for a standing construction of the present invention is a shape with a first and a second end with a tapering circumference from the first end to the second end. This leaves a lighter construction due to the reduced amount of material. The first end, the one with the largest circumferential, is meant to be lowest when used. By placing a wire, fibre rope, pole or a tube which is pre-stressed within the construction and thereby acts to reinforce the construction the necessary strength is obtained. A tube is preferable in a sailboat mast since the tube also can act as an internal halyard channel. Since the composite fibre material is less strong during compression compared to during tension the pre-stressed tube helps converting shear forces to compression forces. Using a solid pole as a pre-stressing device would result in at least equally good mechanical properties. The fibre rope may comprise fibres of polyethene and/or polypropene and/or polyamide and/or poly(tetrafluoro ethylene) and/or poly(ethylene terephtalate) spun using appropriate techniques.

In another embodiment of the present invention the construction contains several pre-stressing devices to further strengthen the construction.

In another embodiment of the present invention the construction comprises one or more pre-stressing devices and a number of anti-shearing devices. It is favourable to place two of the anti-shearing devices so that there is one in each end of the construction while the other are evenly distributed along the mast. These devices should hinder shearing of the material, fatigue of material and should absorb the compression forces from the mountings when they are being pre-stressed.

In yet another embodiment the construction consists of a composite fibre material which comprises fibres that are as long as the construction and lack joints. Since there are no, or just a few, joints, the strength is increased. The individual fibres are advantageously applied at an angle of 0°, 90°, 60° right twist or 60° left twist, with respect to the longitudinal direction of the construction, and are preferably made of glass fibre, or more preferably carbon fibre. The matrix comprises preferably polyester, more preferably epoxy resin.

In another preferred embodiment the foam is composed of polyurethane, vinyl resin and/or epoxy resin. The foam, which is cured in situ, provides extra stiffness to the construction and reduces the risk for resonance oscillations.

In one method of the present invention a post may be produced by first making an outer cover of composite fibre material and then filling the outer cover with the starting material for the polymer foam which then expands and cures in situ. Through the foam curing and expanding in situ the material exerts an opposite force against the outer cover which increases its durability.

### SHORT DESCRIPTION OF THE FIGURES

FIG. 1 shows schematically in cross-section, one embodiment in accordance with present invention with a pre-stressed tube in the middle.

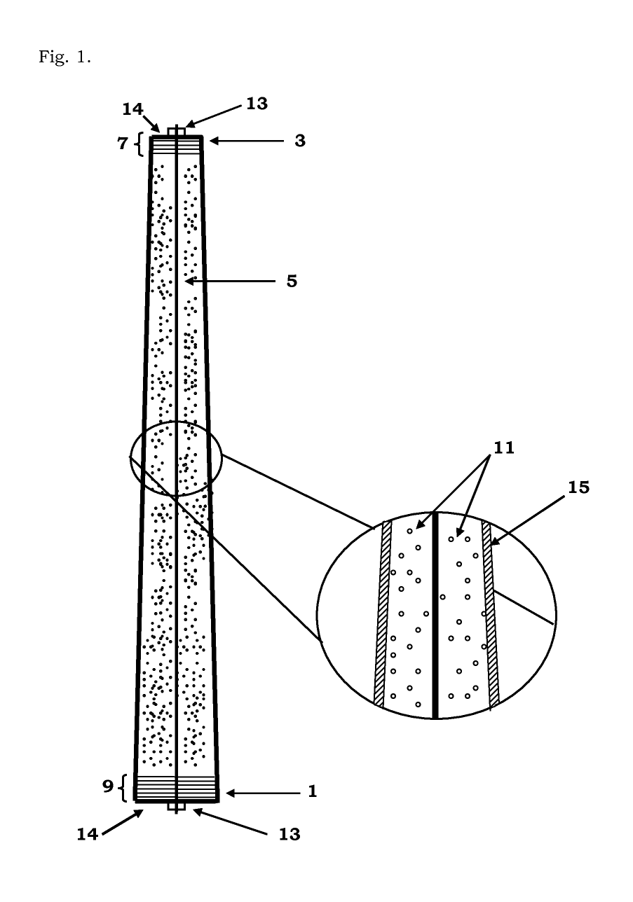

FIG. 2 shows schematically one embodiment in accordance with present invention.

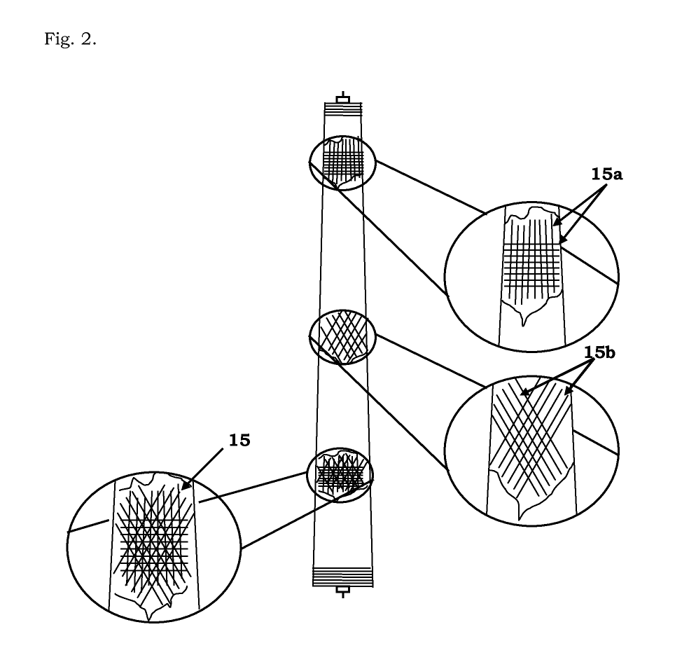

FIG. 3 shows schematically, in cross-section, one embodiment in accordance with present invention with one or more pre-stressing devices in the middle.

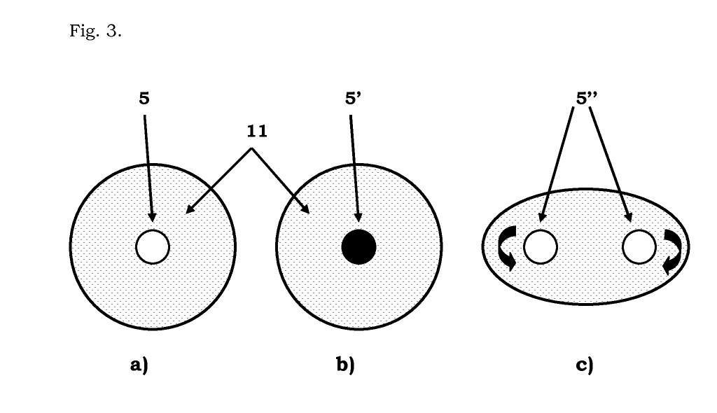

### DETAILED DESCRIPTION OF THE INVENTION

To facilitate the construction of a post which is light but yet durable it is favourable to minimize the amount of material used, to use materials with low densities but at the same time optimize their mechanical properties.

One embodiment according to present invention may have a conventional straight construction but preferably the shape is tapering from a first wide end, 1, towards a second narrower end, 3. The first end is meant to be downwards when used. The tapered shape gives the advantage that the construction becomes lighter. The cross-section of the construction may have any shape and may vary along the construction.

Inside the post there is at least one longitudinal pre-stressing device comprising a tube, fibre rope or a wire, 5, or a pole, 5′, which may be pre-stressed using two mountings, 13, in each end of the post. The mountings can also adjust and position the pre-stressing device. The pre-stressing can be performed during the curing of the polymeric foam or after the foam has cured. The pre-stressing device acts as reinforcement and gives the mast increased durability. The advantage of using a tube as a pre-stressing device instead of a wire is that the tube can act as a halyard channel inside a mast and/or electrical cables can be placed there which then need not to be on the outside of the construction. The pre-stressing device may be made of any suitable material for example metal and/or polymer and/or composite fibre material.

To obtain further stiffness in the construction a torsional force may be built-in during production. This can be accomplished by turning the ends of a pre-stressing device a predetermined number of degrees in each direction, i.e. a first end is turned clockwise and a second end counter clockwise, 5″. Alternatively, one end is kept fixed while the other end is turned. This torsional tension can also be built-in when more than one pre-stressing device is used. The pre-stressing device is retained in the twisted position until the polymeric foam has cured. This retention can be accomplished with a pole, beam, fitting or the like that is placed between the pre-stressing device/devices and one or more fixed positions on the construction or between two or more pre-stressing devices. The retention may be permanent or temporary. The corresponding first and second ends in the different pre-stressing devices are preferably turned in different directions, 5″.

The pre-stressing device is surrounded by cured foam, 11. This foam can be, but is not restricted to, polyurethane foam. The foam not only acts as filler material which gives stability but since it is cured in situ it will exert a permanent pressure on the outer cover which makes the construction become even more durable. The foam also has the function of preventing the pre-stressing device from moving in the construction and minimizes the risk of resonance oscillations.

The outer cover, 15, comprises a composite fibre material where the fibres are preferably made of glass fibre, more preferably aramid fibre, more preferably s-glass (a type of glass fibre) and most preferably carbon fibre. A combination of these fibre materials can also be used. The matrix in the composite fibre material preferably consists of polyester, more preferably polyvinyl ester and most preferably epoxy resin. Combinations of these matrixes can also be used.

On the inside or more preferably on the outside or most preferably on both the inside and the outside, of the outer cover a number of anti-shearing devices, 7 and 9, may be placed. The purpose of these devices is to prevent shearing of the composite fibre material, material fatigue, and to absorb and distribute the pressure forces from the mountings when these are pre-stressed and to absorb the forces arising when the construction is bending, for example due to the wind. These are suitably composed of titanium, stainless steel, aluminium and/or of composite fibre material for example of the same kind as the composite fibre material of the outer cover, preferably glass fibre, more preferably aramid fibre, even more preferably s-glass fibre and most preferably carbon fibre and as matrix preferably polyester, even more preferably polyvinyl ester and most preferably epoxy resin. Combinations of the named materials can also be used. These devices are preferably placed in each end, 1 and 3, of the construction and then evenly distributed along the construction. The number of anti-shearing devices should be at least two, one in each end, and then at those positions where the construction is exposed to point loads across the construction. In a preferred embodiment a 10-metre mast has at least 3 anti-shearing devices, one in each end and one in the deck bearing. The distance between the anti-shearing devices is preferably 5 metres or less, more preferably 3 metres or less and even more preferably 2 metres or less. The width of the anti-shearing devices at the ends should be at least the same as the smallest diameter of the post. The width of the anti-shearing device where the construction is exerted to extra large loads, for example at the deck bearing for a mast, should be at least twice as wide as the corresponding width at the posts widest end.

When the anti-shearing device is composed of a composite fibre material the number of layers should be preferably 3 or more, even more preferably 4 or more and most preferably 5 or more. The fibres used should preferably have no or few joints.

The construction may be produced by making the outer cover first. The fibres, that may be in the form of a knitted or braided cloth or stocking, or which may be applied in several layers, have preferably the directions 0°, 90°, 60° right twist or 60° twist with respect to the construction's longitudinal direction, 15a and 15b. The longitudinal fibres (0°- and 60°-direction) have preferably no or few joints and are at least as long as the construction. The fibres and matrix are applied on a master form and the curing can preferably be performed by heating the composite fibre material to an elevated temperature and thereafter providing controlled cooling during the curing process. After the curing the master form is removed and leaves a composite fibre material tube. The matrix and fibre contents respectively are preferably between 20-40% by weight and 60-80% by weight respectively. A pre-stressed device is placed in the centre of the composite fibre material tube and is pre-stressed. At the narrowest end, 3, a lid is placed, 14, to prevent the foam material from flowing out and to act as a counterforce and to transfer the pre-stressing force to the outer cover during the pre-stressing. The lid may be made of metal and/or polymer and/or composite fibre material. However, there should be a hole in the lid large enough to facilitate gas exchange but small enough to prevent the foam material from flowing out. The starting material for the foam is then added to the composite fibre material tube. The tube is inclined preferably 10-30°, more preferably 15-25°, with the widest end, 1, upwards. A certain inclination is favourable since it facilitates the flow of the starting material down into the construction but the inclination should not be too great because then the material may foam too much. While the starting material is being added the construction simultaneously is rotated and in the widest end, 1, a tube or nozzle is placed for blowing in gas directed diagonally downwards towards the inside of the construction. The gas, preferably air, makes the gas exchange easier during the foaming by creating a vortex of gas inside the construction. An alternative to the hole in the bottom is an embodiment with holes along the whole length, as for example with an external luff groove on a mast, or a combination with holes along the side and the hole at the bottom. In both these cases rotation of the construction when the starting material is added is not necessary since the gas exchange occurs through the many holes.

The present invention may, as mentioned earlier, advantageously be used as, but not restricted to, posts, masts and lampposts but even for constructions that are not standing such as tubes, beams, rotor blades, propeller blades, airplane wings, wind turbine wings, keels or rudders.

1-18. (canceled)

19. Post consisting of a core, comprising a polymer foam, surrounded by an outer cover made of composite fibre material, characterized by a pre-stressing device comprising a pre-stressable wire, fibre rope, pole or tube inside the post.

20. Post according to claim 19 wherein the longitudinal shape has a first and a second end with tapering circumference from the first to the second end.

21. Post according to claim 19 comprising an anti-shearing device in each end.

22. Post according to claim 19 with anti-shearing devices in each position that is exposed to a point load.

23. Post according to claim 19 with fitting in each end which can adjust and/or position and pre-stress the pre-stressing device.

24. Post according to claim 19 where individual fibres have the longitudinal direction 0°, 90°, 60° right twist or 60° left twist with respect to the axial longitudinal direction of the post.

25. Post according to claim 19 comprising an anti-shearing device containing glass fibre or aramid fibre or s-glass or carbon fibre and/or aluminium, steel or titanium or a combination thereof.

26. Post according to claim 19 comprising an anti-shearing device containing polyester or polyvinyl ester or epoxy resin or a combination thereof.

27. Post according to claim 21 wherein the width, in the axial direction of the post, of the anti-shearing devices at the ends is as large as or larger than the smallest diameter of the construction.

28. Post according to claim 19 wherein the length of the longitudinal fibres with respect to the axial longitudinal direction of the post is the same as or longer than the length of the post.

29. Method for producing a post according to claim 19, characterized in that the foam material is added to the post before it is cured and expanded and that the post comprises a hole for gas exchange.

30. Method according to claim 29 wherein the inclination preferably is 10-30°, more preferably 15-25°.

31. Method according to claim 29 wherein the post is rotating during the addition of the starting material.

32. Method according to claim 29 wherein a tube or a nozzle for blowing in gas is placed in an opening at the widest end of the construction.

33. Method according to claim 29 wherein a pre-stressing device is placed in the post and is put under torsional tension.

34. Method according to claim 33 wherein the pre-stressing device is pre-stressed while the foam is curing or after the foam has cured.

35. Method according to claim 33 wherein the ends of the pre-stressing device is fixed using a pole, beam or fitting or the like in its twisted position.

36. Use of a construction according to claim 19 as a post, mast, tube, lamppost, beam, rotor blade, propeller blade, wing, rudder, keel or the like.
